(19) United States
(12) Patent Application Publication
(10) Pub. No.: US 2010/0321178 A1
(43) Pub. Date: Dec. 23, 2010

(54) Alert receiver with linking function

(75) Inventor: Douglas Arthur Deeds, Flower Mound, TX (US)

Correspondence Address: Douglas Deeds, 3633 Dresage Lane, Flower Mound, TX, 75022-7818, US

(73) Assignee: Douglas Deeds, Flower Mound, TX (US)

(21) Appl. No.: 12/488,696

(22) Filed: Jun. 22, 2009

(51) Int. Cl. G08B 1/08

(52) U.S. Cl. 340/539.1

(57) ABSTRACT

Apparatus, and an associated method, for annunciating a hazardous condition at an area encompassed by the annunciating system. The existence of an alert anomaly is annunciated. A receiver is coupled to receive indications of a warning representative of the alert anomaly. The receiver detects reception thereat of the indications of the warning. An annunciator is coupled to the receiver. The annunciator annunciates, in human perceptible form, the detection at the receiver of the indications of the warning representative of the alert anomaly. A transceiver is coupled to the receiver. The transceiver enables communication with similar apparatus to exchange settings, enable user control of remote devices, and exchange alert and non-alert conditions and audio.

### BACKGROUND OF THE INVENTION

1. Field of the Invention

This invention relates to alert receivers and, more particularly to an alert receiver having an integrated linking function.

2. Relevant Background

Use of alert receivers has become increasing necessary and popular, both as a life saving measure from hazardous conditions and also as a simple means to obtain day-to-day weather conditions and forecasts.

The National Weather Service (NWS) is an agency with the Department of Commerce's National Oceanic and Atmospheric Administration. Beginning in the late 1950s, the NWS, then the U.S. Weather Bureau, started developing a voice radio broadcast system to provide more frequent and specialized weather information to the general public and users with unique weather needs than was available from the commercial radio and television services. The service was eventually named NOAA Weather Radio (NWR). Operating frequencies are in the Federal Government's Very High Frequency (VHF) band between 162.400 and 162.550 MHz.

A special feature of the NWR system that evolved in the 1960s was the transmission of a single tone at 1050 Hz prior to the broadcast of any message about a life or property-threatening event. This became known as the Warning Alarm Tone (WAT). Special receivers that are electronically switched on and receiving the broadcast signal, but the speaker is in a muted state, are made by several companies. When this type of radio detects the WAT, it automatically turns on the speaker allowing the alerting tone, then the alert message to be heard without the need for the owner/user to do anything.

Starting in 1985, the NWS began experimenting with putting special digital codes at the beginning and end of any message about a life beginning and end of any message about a life or property-threatening event. The intent was to ultimately transmit a code with the initial broadcast of all NWR messages. The system evolved into what is known today as NWR Specific Area Message Encoding (NWR SAME). The general specifications are described briefly in the following sections. Complete and up-to-date specifications can be obtained by contacting the National Weather Service.

The main purpose of the code created by NWR SAME is to provide enough information before and after the broadcast of a message so software routines can match preprogrammed user instructions. Its greatest value is to significantly improve the automatic selection and distribution of messages about events that threaten people and/or property.

An NWR SAME transmitted data message consists of six possible elements in the following sequence:

1) Preamble

2) Header code

3) Warning Alarm Tone/Attention Signal

4) Voice Message

5) Preamble

6) End of Message

The coded message is transmitted, using audio frequency shift keying (AFSK), on the audio channel of the VHF NWR transmitter system. It is transmitted at no less than 80% modulation (+/−4.0 kHz deviation minimum, +/−5 kHz deviation maximum). The coded message and voice program audio is transmitted using standard pre-emphasis for narrow band VHF FM of 6 dB per octave increasing slope from 300 Hz to 3 kHz applied to the modulator.

The preamble and header code are transmitted three times with a one second pause (+/−5%) between each coded burst prior to the broadcast of the actual message. The End Of Message (EOM) consists of the preamble and EOM code transmitted three times with a one second pause (+/−5%) between each EOM burst. Each header and EOM data transmission consists of a string of eight 8-bit bytes with no start, stop, or parity bits. Bit and byte synchronization is attained by a preamble code at the beginning of each header code or EOM data transmission. Data transmissions are phase continuous at the bit boundary.

One bit period equals 1920 microseconds (+/−1 microsecond). This equates to a data rate of 520.83 bits per second. A logic zero is 1562.5 Hz, a logic one is 2083.3 Hz.

The first 16 bytes (prior to the header code and EOM) of the data transmission is a preamble with each byte having the same value of hexadecimal AB (8 bit byte [10101011]). For all bytes, the least significant bit (LSB) is sent first. The bytes following the preamble constitute the actual message data transmission. The message data (header) code is transmitted using ASCII characters as defined in ANSI X.3.4-1977 with the eighth (8th) bit always set to zero.

The Warning Alarm Tone (WAT), if transmitted, is sent within one to three seconds following the third header code burst. The frequency of the WAT is 1050 Hz (+/−0.3%) for 8 to 10 seconds at no less than 80% modulation (+/−4.0 kHz deviation minimum, +/−5.0 kHz deviation maximum).

If transmitted, the actual voiced message begins within three to five seconds following the last NWR SAME code burst or WAT, whichever is last. The voice audio ranges between 20% modulation (+/−1 kHz deviation) and 90% modulation (+/−4.5 kHz) with occasional lulls near zero and peaks as high as but not exceeding 100% modulation (+/−5 kHz deviation). The total length of the message should not exceed two minutes.

NWS does occasionally send a continuous string of Preamble code, (Hex AB) or a continuous tone through its communications links to the NWR transmitters, for several seconds up to around one minute. This is done to align the program console, communications links, and transmitters for optimum system performance.

In symbolic form, the message code format is:

(Preamble) ZCZC−WXR−EEE−PSSCCC−PSSCCC+TTTT−JJJHHMM−LLLLLLLL−

(one second pause)

(Preamble) ZCZC−WXR−EEE−PSSCCC−PSSCCC+TTTT−JJJHHMM−LLLLLLLL−

(one second pause)

(Preamble) ZCZC−WXR−EEE−PSSCCC−PSSCCC+TTTT−JJJHHMM−LLLLLLLL−

(one to three second pause)

1050 Hz Warning Alarm Tone (WAT) for 8 to 10 seconds (if transmitted) Verbal/spoken oral text of message (if transmitted)

(Preamble) NNNN
(one second pause) (Preamble) NNNN
(one second pause)

(Preamble) NNNN

Symbol definitions:

(Preamble)

This is a consecutive string of bits (sixteen bytes of hexadecimal AB [8 bit byte 10101011]) sent to clear the system, set automatic gain controls, and set asynchronous decoder clocking cycles. The preamble must be transmitted before each header code and EOM code.

“ZCZC−”

This header code block is the identifier, sent as ASCII characters ZCZC to indicate the start of the ASCII header code data transmission.

“-” (Dash)

This “Dash” is sent following each type of code information block in the header except prior to the message valid time.

“WXR-”

This header code block identifies the message as a voice message from a

NWR system transmitter. There are other identifiers used by EAS stations as defined in FCC rules Part 11.

“EEE-”

This header code block identifies the type of event and information contained in the verbal message, if a verbal message is sent. The event code may be sent with or without a WAT or verbal message as an alerting function only. It also may be sent as a control code for some NWR system control functions.

“PSSCCC-”

This header code block identifies the geographic area affected by the NWR SAME message. Each block of this coded information uniquely identifies a geographical area. A message may contain up to 31 blocks.

This part of the geographical area header code block allows for subdividing the area defined by the “CCC” into smaller parts in the case of very large or uniquely shaped area, or because of widely varying height, climate, or other geographic features. If a “P”=0, it means the entire or unspecified are defined by “CCC” is affected. If the “P” equals a number other than zero, the areas are defined as follows:
1=Northwest 1/9
2=North Central 1/9
3=Northeast 1/9
4=West Central 1/9
5=Central 1/9
6=East Central 1/9
7=Southwest 1/9
8=South Central 1/9
9=Southeast 1/9

If the part is larger than 1/9 of the “CCC”, the following numbering convention is normally used depending on the desired size and/or orientation of the area such as from Northwest to Southeast, North to South, West to East, or

Northeast to Southwest:
1=Northwest ⅓ or ½ as appropriate
2=North ⅓ or ½ as appropriate
3=Northeast ⅓ or ½ as appropriate
4=West ⅓ or ½ as appropriate
5=Central 1/3
6=East ⅓ or ½ as appropriate
7=Southwest ⅓ or ½ as appropriate
8=South ⅓ or ½ as appropriate
9=Southeast ⅓ or ½ as appropriate

“SS”

This part of the geographical area header code block is the number of the state as defined by the Federal Information Processing System (FIPS) number as described in the U.S. Department of Commerce in National Institute for Standards and Technology (NIST) publication #772. Special “SS” codes are assigned to those areas not defined by this publication such as the open waters of the Atlantic, Pacific, Gulf of Mexico, and Great Lakes. The most current list of special “SS” codes may be obtained from the NWS or the FCC upon request.

“CCC”

This part of the geographical header code block is a number normally assigned to each country in the United States by the FIPS. Special “CCC” codes are assigned to those areas not defined by the NIST publication #772. These include the open waters of the Atlantic, Pacific, Gulf of Mexico, and Great Lakes and to special alerting zones adjacent to and near unique storage or production facilities. A “CCC” of 000 applies to the entire state or area identified in the “SS” section of the code. The most current list of these special “CCC” codes may be obtained from either the NWS or the FCC upon request.

Location codes transmitted over NOAA Weather Radio frequencies, but originated originally by security or communications centers at special hazardous materials storage or production facilities, my contain a combination of numbers, letters, and other characters. The authorized set is ASCII characters decimal 10, and 13 and decimal 33 through decimal 127. ASCII characters decimal 43 and 45 may not be part of the six character location code, but used only at the end of the block as shown previously in the symbolic form. The ASCII character decimal 42, “*”, is reserved for use as a wild card only. These become special location codes containing a combination of geographic and instructional information to activate customized receivers, pre-stored text messages, and/or other special equipment.

These codes will not be sent as part of NWS originated NWR SAME messages. NWR receivers with SAME decoders should not respond to such codes for NWS NWR or EAS purposes. Systems receiving NWR broadcasts and providing further redistribution may want to pass them along in any retransmission of the header code. Radio, television, or cable systems covered by FCC Rules Part 11 are not prohibited from using these codes in peripheral equipment or ancillary functions to basic EAS equipment to further enhance the safety of the public in cooperation with local government officials or facility managers.

An NWR or EAS text standard over and above this special application of the location code is not defined under these specifications or EAS rules. A text standard could be developed using the basic NWR SAME/EAS protocol, but identified as a test message using a variation of the Originator code. The Originator Code in this section is reserved for voice messages only and decoders should reject any message that does not match this currently defined code set.

Numbers from 900 to 999 are reserved for assignment to unique non-FIPS defined alerting areas adjacent to facilities that store or produce nuclear, chemical, and biological material. For the most current list of these areas, contact the NWS or FCC.

“+TTTT−”

This header code block identifies the purge time of the message expressed in a delta time from the issue time in 15 minute segments up to one hour. Then in 30 minute segments beyond one hour up to six hours; IE +0015−, +0030−, +0045−, +0100−, +0430−, +0600−. This delta time, when added to the issue time, specifies when the message is no longer valid and should be purged from the system, not to be used again. It is important to note that the valid or purge time of the message does not always equal the event expiration time. For most short-term events such as tornadoes and thunderstorms, the two times will most often be identical. For longer duration events, such as a hurricane or winter storm that may not end for many hours or days, the valid time in the code only applies to that message, and is not an indicator that the threat is over.

Alert receivers are being purchased in every increasing numbers as a means for consumers to become alerted to severe weather and other conditions. The alerts provide time for the users to both seek adequate shelter from life-threatening weather and to protect property. Alert receivers are also commonly used to obtain weather forecasts to plan outdoor and other day-to-day personal activities. Units containing SAME decoders have removed the annoyance of alerts not in the geographical location of the receiver so usage has increased.

Alert receivers are currently available both as portable units and as tabletop units to facilitate their use in different environments. In either of these roles, current receivers are limited in their effectiveness of alerting users. Due to practical and cost limitations, current designs can only alert users within a limited range of audibility from the alert receiver. Users can only tolerate a limited sound intensity when they are in close proximity to the device, so the far range of audibility of the device is limited by the nearby sound level (i.e. an arm's length from the user to the speaker or other audio output transducer). The range of audibility is decreased by objects, such as furniture or doors, between the alerting device and the user. The range of audibility may also be reduced by the poor sound reflectivity of surfaces caused by such home decorations as curtains and carpeting. The range of audibility may be lowered further by the physical layout of the user's premises. The size of the user's premises may also be larger than the maximum audible range of the alerting device. Some units such as Radio Shack models 12-249 and 12-250 allow connection of an external siren to increase the sound level, but doing so is beyond the skill of most users. The use of an external siren can also exacerbate the problems related to high sound intensity. User's are also unlikely to run wiring from the receiver to the siren due to the poor aesthetics of the wiring.

Practical and aesthetic limitations limit the maximum size of the antenna that can be mounted on portable and tabletop weather alert receivers. This limits their receiver performance. To improve reception, some units such as Radio Shack models 12-247 and 12-250 allow external antennas to be connected. But again this is usually done only by skilled users. The minimum physical size of the antenna is dictated by the wavelength of the received signal (one wavelength is approximately 1.85 meters) and by the need for good reception. A sampling of antennas for receivers currently on the market included lengths of 20 to 22 inches (slightly longer than ¼ wavelength). Consequently, practical and aesthetic considerations limit where users are willing to locate their alert receivers. An example of a practical limit would be the desire of a user to have an alert receiver in the basement of their house for monitoring during a severe weather condition such as a tornado, but being unable to do so due to limited reception below ground level. An example of an aesthetic limit would be the desire to position an alert receiver in the living room, but being unwilling to do so due to the long antenna being perceived as unwieldy or ugly. For example, user's probably would be unlikely to place a receiver on a coffee table regardless of the improvement in having the device central to the user's living area.

Some alert conditions, such as tornadoes or tsunamis, require immediate recognition by the user so they can adequately prepare for the event. Users are likely to place the receiver in a location such as a living room or bedroom, where it has the highest likelihood to be heard. Even when the alert siren can be heard at other locations, the user may not be in the vicinity of the receiver to immediately hear the alert broadcast or view the text display of SAME data to identify. Users with physical impairments to rapid movement such as the elderly, persons in wheelchairs, etc. cannot quickly reach the alert receiver. Persons with hearing impairments must move close to the location of the receiver to see the text display of the alert receiver in order to determine the type of alert. Thus some persons may lose valuable time that could be otherwise used to reach a safe location. While users could carry a portable device within their household to decrease the time to respond, this is highly inconvenient and a portable device may not provide adequate reception compared to another device with a superior antenna. A better solution would be to deploy multiple receivers in a household, but this introduces additional problems for users. If receivers are located too close to each other, the alert sounds may be too loud for the ears of users and there may be auditory distortion due to the user hearing the audio from multiple receivers with spatially caused delays. Subsequently, the user might be required to silence other alert receivers before being able to listen to a particular alert receiver. In addition, the user might need to quickly silence multiple units in order to not disturb others, such as sleeping children or babies. The user also has the initial chore of the programming and set up of multiple alert receivers.

A discussion of the related art of which the inventor is aware, and its differences and distinctions from the present invention, is provided below.

U.S. Pat. No. 7,050,784, Weather Radio with Channel Acquisition System, describes a method to automatically select a preferred channel of operation. Recent alert receivers such as the Radio Shack model 12-262 intelligently scan the entire alert frequency band to find the signal with best quality. This is determined by looking for the highest received signal strength, highest signal to noise ratio, or highest carrier to noise ratio. This is an excellent method for finding the optimal signal for the receiver under normal operation conditions, but provides no redundancy in the event of failure or degradation of the signal of the selected NWS transmitter.

U.S. Pat. No. 7,130,600, Apparatus, and an associated method, for facilitating entry of location information at a weather band radio or other receiving station, describes a method for a SAME receiver to generate the 6 digit FIPS code using positional information input by the user of a receiver instead of directly entering the numerical FIPS code. While this can simplify setup of an alert receiver, any code, either positional or numeric, must be entered for each receiver at a premises increasing the likelihood of erroneous input.

Publication US 2007/0194906, All Hazard Residential Warning System, describes use of a combination of mesh and community wide networks connected to the Internet to signal emergency conditions. The system is inferior to the current invention for multiple reasons including the likely inaccessibility of the Internet during some emergency conditions and the use of transmission frequencies that do not penetrate structures as readily as the NOAA alert signals.

U.S. Pat. No. 6,744,351 describes a Central Radio Device And Associated Appliance. This system is inferior to the current invention in that the central device must be located at a location with sufficient signal for the alert receiver, uses appliances which are not battery backed up as remote signaling devices, and provides no redundancy in the event of the primary transmitter failing.

Publication US 2003/0184436, Security System, describes a feature of a security system that can transmit voice and other audio of an alarm to other security systems within the same neighborhood. This feature only transfers audio and does not allow remote control of the systems.

Publication US 2007/0100819, Method to decode a data string, describes a method to decode the multiple sets of received data from a NOAA Weather Radio transmission to improve the recovery of data from poor reception. This invention is inferior to the current invention since it only has the received data from one receiver to process.

Publication US 2003/0179089, Emergency Warning System, describes a relay system where a system of sensors transmit an environmental condition to a receiver connected to a transmitter which relays the condition to multiple receivers in a secondary broadcast band. This system provides no redundancy for reception of the environmental condition transmissions.

Publication US 2007/0013532 describes a combination thermostat and warning device that includes a receiver for broadcasts from the NWS. This system is inferior to the current invention since it does not provide redundancy for reception of the NWS broadcasts and does not provide voice audio or textual alert information to a plurality of devices.

Publication US 2004/0235416 describes a method to facilitate setup of the FIPS code for selectively alerting for the geographical area of interest. This system is inferior to the current invention since it requires that the user set up a plurality of alert receivers individually.

Publication US 2008/0227418 describes a method for monitoring multiple NOAA channels to acquire warning alert data. Although this solution is an improvement to most currently implemented alert receivers, this method is inferior to the current invention since it provides no positional diversity for signal reception.

Publication US 2009/0002181, Disaster warning system, describes a system containing a weather radio, a tornado acoustic-signature detector combined with a smoke detector, and a carbon-monoxide detector. While this system would indeed provide a safety benefit to end users, it does not provide any capability for receiver diversity, single setup of a plurality of receivers, or a plurality of text or audio annunciators for distribution of alerts throughout the premises of a house or business.

Furthermore, the above related art does not disclose the ability to assume remote control auxiliary devices of a similar nature as will be subsequently disclosed.

### SUMMARY OF THE INVENTION

This invention relates to alert receivers and, more particularly to an system of alert receivers having a linking function.

The present invention advantageously provides, therefore, apparatus, and an associated method, for annunciating a hazardous condition at an area encompassed by the annunciating system. The existence of an alert anomaly is annunciated. A receiver is coupled to receive indications of a warning representative of the alert anomaly. The receiver detects reception thereat of the indications of the warning. An annunciator is coupled to the receiver. The annunciator annunciates, in human perceptible form, the detection at the receiver of the indications of the warning representative of the alert anomaly. A transceiver is coupled to the receiver. The transceiver enables communication with other similar apparatus to exchange settings, enable user control of remote devices, and exchange alert and non-alert conditions and audio.

The foregoing and other features, utilities and advantages of the invention will be apparent from the following more particular description of a preferred embodiment of the invention as illustrated in the accompanying drawings.

### BRIEF DESCRIPTION OF THE DRAWINGS

FIG. 1 is a block diagram of a conventional alert device.

FIG. 2 is a block diagram of the radio frequency receiver and decoder of an alert device.

FIG. 3 is a block diagram of a linked alert device.

FIG. 4 is a block diagram of a system of linked alert devices

### DETAILED DESCRIPTION OF THE PREFERRED EMBODIMENTS

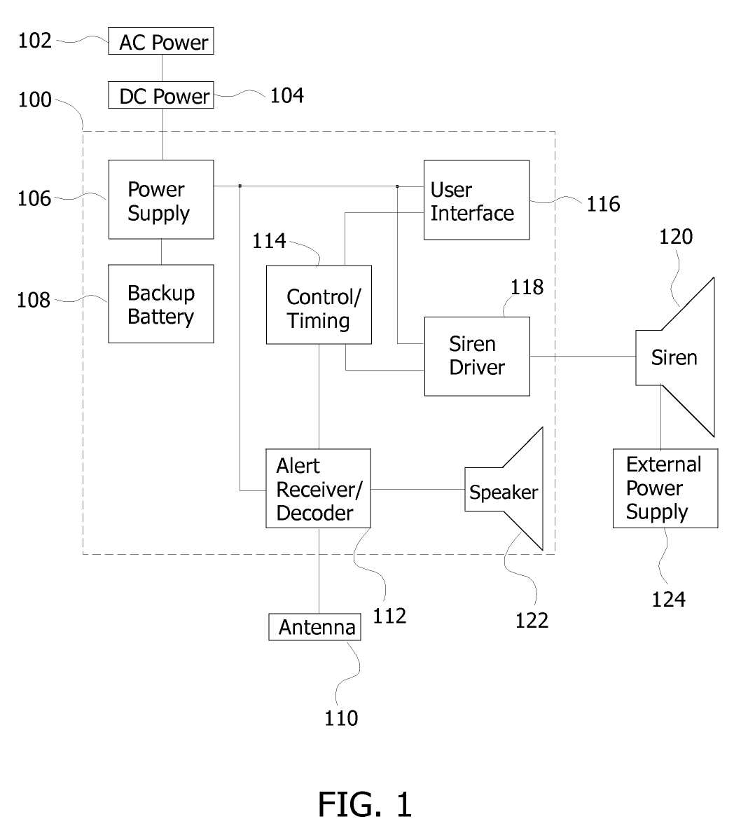

FIG. 1—Conventional Alert Receiver

FIG. 1 shows a functional alert system. The system monitors one or more alert frequencies and initiates an alert cycle when specified conditions occur.

The alert receiver 100 encompasses the circuitry of the system.

DC power supply 104 is conventional; it receives high voltage alternating current (AC) from the mains supply 102 and outputs low voltage direct current.

Power supply 106 is conventional; it receives low voltage direct current power from the DC power supply 104 and supplies one or more direct current (DC) voltages to the rest of the alarm system. The distributed voltages may be regulated or unregulated depending on their ultimate use in the system. Backup battery 108 comprises one or more primary cell batteries and supplies power to the rest of the system when AC mains power is unavailable.

Alternatively, DC power supply 104 and power supply 106 could be combined into a switching power supply that takes mains level AC and converts it to direct current for the rest of the alarm circuitry.

Antenna 110 provides a means for obtaining a radio frequency signal in the NOAA weather band (162.400 MHz to 162.550 MHz) of sufficient strength to provide usable audio and data under all conditions.

Alert receiver and decoder 112 is a standard narrow-band FM receiver used in conjunction with circuitry to filter and decode the audio frequency shift keying (AFSK) data containing weather alerts, decode and qualify the WAT tone, and digitally compress the audio of the alert message. The outputs of the alert receiver and decoder 112 connect to the control and timing logic 114 for determination of alert conditions. The alert receiver and decoder 114 outputs the audio of weather broadcasts and alerts to speaker 122 for listening under the control of the local user interface 116.

The control and timing logic 114 provides intelligence for the system and may consist of discrete timing and logic circuitry, but more typically is a microcontroller or microprocessor with external memory. The microcontroller or microprocessor processes alert states to determine if a change in the state of the system is required. If a change of state is needed, the microcontroller or microprocessor will change its internal status as well as changing the state of outputs, such as sirens, relays, or speakers. The microcontroller or microprocessor will also change the status presented to the user through the user interface 116. User interface 116 may consist of a combination of light emitting diodes (LEDs), a liquid crystal display (LCD), a polymer light emitting diode display (PLED), a organic light emitting diode display (OLED), or any other type of display technology in addition to a means for the user to interact with the device using switches, keys, capacitive touch sensing, or some other input technology. The status is also presented to the user through audible output devices such as the siren 120. Processing of inputs and changing of output states may occur synchronously or asynchronously with other events in the system.

Siren driver 118 includes circuitry that provides a contact closure to connects one or more sirens 120 to an external power supply 124. The siren 120 contain circuitry to generate and amplify an audio signal to a high audio level.

The local user interface 116 provides functionality for a user to program the system, and/or to indicate the status of the system, including alerts.

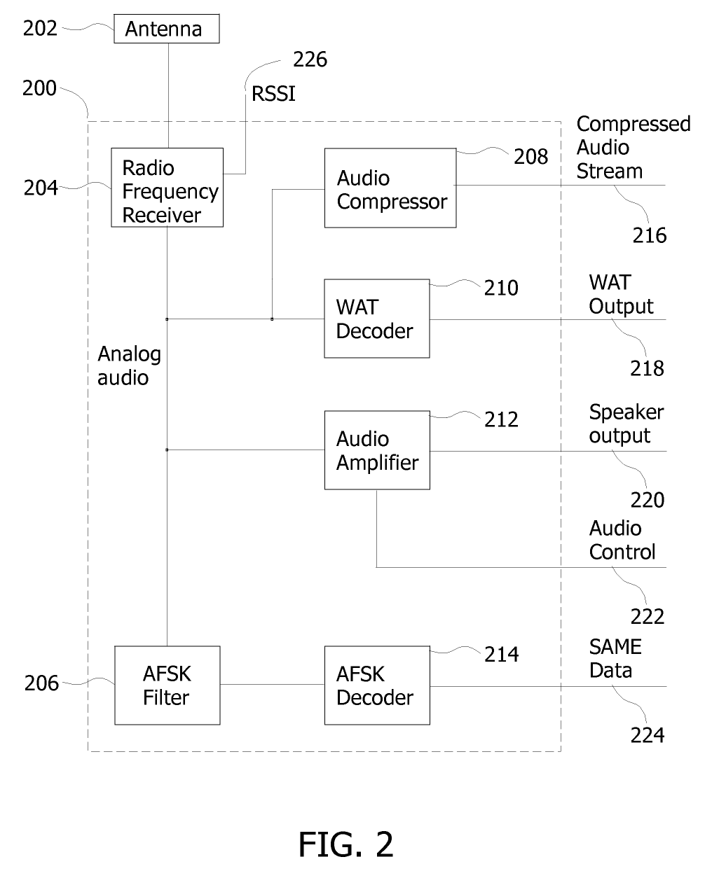

FIG. 2—Alert Receiver

FIG. 2 shows the elements of a functional receiver to detect and decode alert broadcasts.

The weather alert receiver and decoder 200 consists of electronic circuitry to receive the SAME alert transmissions, demodulate the audio containing the verbal weather alert, and decode the transmitted data containing the weather alert in symbolic form.

The antenna 202 provides a means for obtaining a radio frequency signal in the NOAA weather band (162.400 MHz to 162.550 MHz) of sufficient strength to provide usable audio and data under all conditions. A telescoping whip antenna is sufficient for most installations. However, for systems in locations at the fringe of the NWS station's reception area an larger external antenna such as a dipole or a vertical wire will be needed to increase the received signal to an acceptable level.

The radio frequency receiver 204 is a standard narrow band VHF FM receiver designed to receive the 7 frequencies broadcast by the NWS. A wide variety of special integrated circuits for this function are available including the Numa Technologies NT2906. Operating parameters should match the signal specifications from the NWS. Received signal strength indication (RSSI) output 226 is coupled to a microcontroller to enable the microcontroller to intelligently select the optimum channel to receiver alert stations.

The AFSK (audio frequency shift keying) filter 206 can be as simple as a standard bandpass filter implemented in analog circuitry.

The audio compressor 208 is analog and/or digital circuitry to convert the audio into a digital representation that can be serially transmitted for remote listening. Standard compression techniques such as continuously variable delta modulation (CVSD) and adaptive differential pulse code modulation (ADPCM) give sufficient quality at low bit rates for the weather alert audio. The NWS has recently begun using computer-synthesized speech for the weather radio broadcasts. So care should be taken to choose a compression and bit rate that does not overly distort the lower quality speech signal. The compressed audio is passed via the compressed audio stream 216 to the device control/timing section for distribution throughout the system. The compressed audio stream 216 can be in a serial or parallel format.

The WAT (Warning Alert Tone) decoder 210 is a standard tone decoder such as a National Semiconductor LM567. The WAT decoder is tuned to detect the 1050 Hz tone broadcast preceding the voice alert portion of a weather alert. The determination of a tone of sufficient duration to indicate an alert can be made by discrete circuitry or by the microcontroller or microprocessor of the system. The indication of a detected WAT tone is connected to the system through the WAT output 218.

The audio amplifier 212 is a standard amplifier for the audio band, 300 Hz to 3 kHz, such as the National Semiconductor LM386 or equivalent. The audio amplifier is connected through the speaker output 220 to a speaker for listening in the vicinity of the alert device. The audio amplifier 212, including volume control and mute functions, is under the control of the alert devices microcontroller or microprocessor through the audio control 222 connection.

The AFSK decoder 214 is a standard integrated circuit such as the EXAR 2211A specifically designed for FSK demodulation. The serial data stream is passed as a digital signal to the system microcontroller or microprocessor through the SAME data 224 connection.

Note that the functions of the AFSK filter 206, audio compressor 208, WAT decoder 210, and AFSK decoder 212 can be performed in software running on a high speed microcontroller, microprocessor, or digital signal processor (DSP). Examples of such parts are the Microchip Technology dsPIC30 and dsPIC33 digital signal controllers and Texas Instruments TMS320C55X digital signal processors.

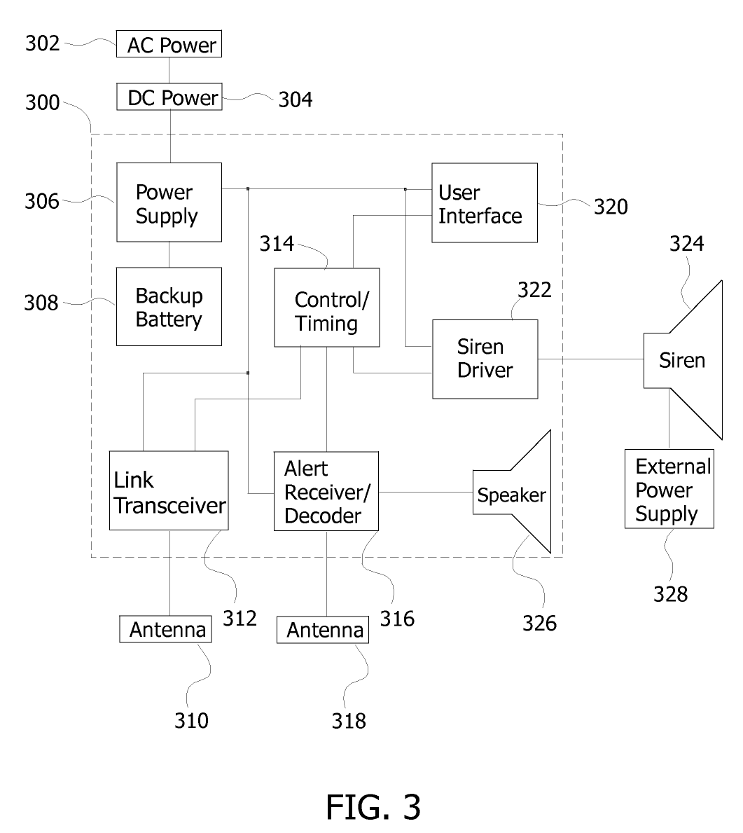

FIG. 3.—Linked Alert Receiver

FIG. 3 shows a functional linked alert receiver. The receiver monitors one or more alert frequencies and initiates an alert cycle when specified conditions occur.

The alert receiver 300 encompasses the circuitry of the system.

DC power supply 304 is conventional; it receives high voltage alternating current (AC) from the mains supply 302 and outputs low voltage direct current.

Power supply 306 is conventional; it receives low voltage direct current power from the DC power supply 304 and supplies one or more direct current (DC) voltages to the rest of the alarm system. The distributed voltages may be regulated or unregulated depending on their ultimate use in the system. Backup battery 308 comprises one or more primary cell batteries and supplies power to the rest of the system when AC mains power is unavailable.

Alternatively, DC power supply 304 and power supply 306 could be combined into a switching power supply that takes mains level AC and converts it to direct current for the rest of the alarm circuitry.

Antenna 310 provides a means for obtaining a radio frequency signal in the NOAA weather band (162.400 MHz to 162.550 MHz) of sufficient strength to provide usable audio and data under all conditions.

Alert receiver and decoder 312 is a standard narrow-band FM receiver used in conjunction with circuitry to filter and decode the audio frequency shift keying (AFSK) data containing weather alerts, decode and qualify the WAT tone, and digitally compress the audio of the alert message. The outputs of the alert receiver and decoder 312 connect to the control and timing logic 314 for determination of alert conditions. The alert receiver and decoder 316 outputs the audio of weather broadcasts and alerts to speaker 326 for listening under the control of the user interface 320

The control and timing logic 314 provides intelligence for the system and may consist of discrete timing and logic circuitry, but more typically is a microcontroller or microprocessor with external memory. The microcontroller or microprocessor processes alert states to determine if a change in the state of the system is required. If a change of state is needed, the microcontroller or microprocessor will change its internal status as well as changing the state of outputs, such as sirens, relays, or speakers. The microcontroller or microprocessor will also change the status presented to the user through the user interface 320 User interface 320 may consist of a combination of light emitting diodes (LEDs), a liquid crystal display (LCD), a polymer light emitting diode display (PLED), a organic light emitting diode display (OLED), or any other type of display technology in addition to a means for the user to interact with the device using switches, keys, capacitive touch sensing, or some other input technology. The status is also presented to the user through audible output devices such as the siren 324. Processing of inputs and changing of output states may occur synchronously or asynchronously with other events in the system.

Siren driver 322 includes circuitry that provides a contact closure to connect one or more sirens 324 to an external power supply 328. The siren 324 contain circuitry to generate and amplify an audio signal to a high audio level.

The local user interface 320 provides functionality for a user to program the system, and/or to indicate the status of the system, including alerts.

Link transceiver 312 provides connectivity between the alert receiver 300 and other compatible alert receivers. The link transceiver 312 is a conventional transceiver IC, such as the Texas Instruments CC2520 or Numa Technologies NT2906.Antenna 310 is a conventional antenna suitable for the transmit and receive frequencies. Antenna 310 may be a whip type antenna or instead be part of the PCB assembly of the link receiver 300. Antenna 310 may also be combined with antenna 318. Link transceiver 312 provides the alert receiver 300 with the functionality to communicate with other alert receivers to send and receive control commands, send and receive alert data, send and receive audio, send and receive receiver channel usage and assignment, and send and receive remote programming.

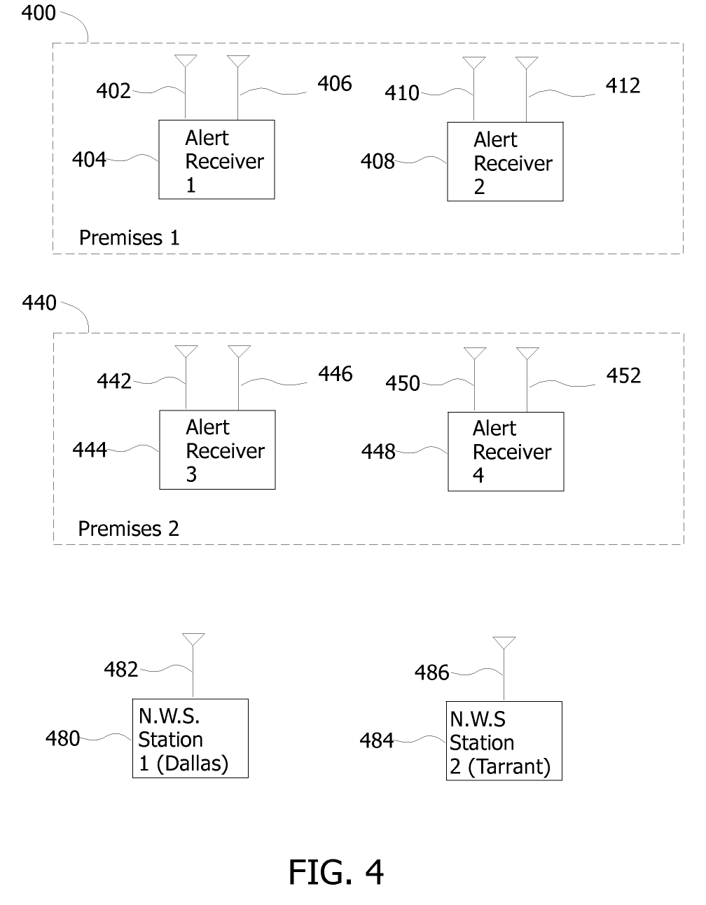

FIG. 4.—Block Diagram of Linked Alert Devices

FIG. 4 shows a functional block diagram of a system of linked alert devices.

System 400 comprises a first independent system of linked alert devices located at a first premises. The system 400 contains two linked alert devices, 404 and 408. Alert device 404 receives alert broadcasts through antenna 402.

Similarly, alert device 408 receives alert broadcasts through antenna 410. Alert device 404 transmits and receives linking transmissions through antenna 406. Alert device 408 transmits and receives linking transmissions through antenna 412.

System 440 comprises a second independent system of linked alert devices located at a second premises. The system 440 contains two linked alert devices, 444 and 448. Alert device 444 receives alert broadcasts through antenna 442. Similarly, alert device 448 receives alert broadcasts through antenna 450. Alert device 444 transmits and receives linking transmissions through antenna 446. Alert device 448 transmits and receives linking transmissions through antenna 452.

System 400 and system 440 while fully functional as independent systems they may also link together briefly or longer term to send and receive alert data, send and receive audio, send and receive receiver channel usage and assignment, and send and receive programming information.

An exemplary first National Weather Service station 480 is located in Dallas county, Texas and transmits weather and alert broadcasts through antenna 482. A second exemplary National Weather Service station 484 is located in Tarrant county, Texas and transmits weather and alert broadcasts through antenna 486.

### Preferred Embodiment—Operation

During the non-alert condition of the alert device 300, the user interacts with the system through the local user interface 320. To set up and initialize a first alert device 404 (an instance of 300), the user would insert the backup battery 308 and connect the DC adapter 304 to the device 300 and to AC power 302. The alert device 300 would recognize that it had not been previously initialized and scan the weather band channels using radio frequency receiver 204 to determine which channel or channels are optimum for receiving alert broadcasts. Alert device 300 would subsequently present a choice to the user to select automatic or manual setup.

Selecting automatic setup would initiate the alert device 400 to search for other alert devices in range. Alert device 400 would use its link transceiver 312 and antenna 310 to transmit messages requesting other units to respond. If no other units respond, then the user would be requested to enter or select a unique code for their premises. The code would then allow other units added to the system 400 to determine which alert devices should be linked. Alternately, the alert device 300 may select its own unique code that would be presented to the user using the user interface 320 for subsequent identification with other alert devices.

If a second alert device 408 responded to the request message through link transceiver 312 and antenna 310, the alert device 300 would present the user with messages on the user interface 320 to allow them to make further selections. For example, if alert device 408 was already initialized, alert device 404 would request data from alert device 408 to determine the county, state, and sub-county (FIPS) code or codes for the premises of system 400. The alert device 404 would present the user with the choice of selecting all or a subset of the imported codes. For example, alert device 408 might be programmed to alert for the FIPS codes for both Tarrant and Dallas counties, but the user might select only Tarrant county for monitoring with alert device 404. Further, the alert device 404 might also request data from alert device 408 for additional settings such as the alert types that are accepted, blocked, user interface settings, like volume, display contrast and backlighting intensity, etc. The net result is that device 404 would effectively clone the settings of device 408.

Subsequently, if the user determined that alert device 408 was in fact also their own device, the user would choose to link the units permanently thereby creating the linked system 400. A consequence of creating a linked system 400 might be that each alert device 404 and 408 might allow the user to elect to decrease the sound level of the alert to each speaker 326 since each unit 404 and 408 would not be required to sound throughout the entire premises.

The alert devices of linked system 400 may be located so that alert device 404 is only in reception range for Dallas County NWS station 480 while alert device 408 is only in reception range for Tarrant County NWS station 484. The alert devices of linked system 400 may exchange their weather band reception information for use in non-alert and alert modes. It is anticipated that linked systems will be set up with devices in locations where one or more of the receivers are not on the same channel due to different reception at each device. Further, while it is anticipated that each alert device of linked system 400 will have adequate reception of at least one NWS station, the linked system 400 can operate with a minimum of at least one alert receiver 300 with reception of a single NWS station. For example, in linked system 400, alert receiver 404 might be located on the first or second floor of a house and thus have adequate reception. However, alert receiver 408 may be, for usability reasons, located in the basement of the house and thus unable to receive any NWS station. In this example of a linked system 400, alert receiver 408 allows the user to listen to audio from the NWS station received by alert receiver 404 by requesting the audio by means of one or more commands via the link transceiver 312 in each of the alert receivers 404 and 408.

Another benefit resulting from the linked system 400 would be the exchange of other information, such as the time and date. The user might update the time on alert device 404 and the time would be exchanged with alert device 408 and subsequently updated on alert device 408.

Another benefit resulting from the linked system 400 would be the exchange of test alert messages. NWS stations transmit weekly test messages unless there is a likelihood of an actual alert on the test day. In the linked system 400, alert device 404 may receive the weekly test alert while alert device 408 does not. In this event, the linked system 400 may alert the user to the problem detected. Or alternately the linked system may reassign the alert device 408 to another channel such as the one in use by alert device 404. In the event of the continued failure to receive alerts, alert device 408 may then be associated to alert device 404 as the channel to receive alert data and both alert and non-alert audio.

If either the third alert device 444 or fourth alert device 448 responded and the second alert device 408 did not respond, the user would recognize that the alert devices were not located at her premises and would be presented with the choice to load the FIPS codes that are programmed into alert devices 444 or 448. Other settings, such as radio channels, date, and time, may also be imported into alert device 404 at the choice of the user. Devices in linked systems 400 and 440 might also exchange and compare weekly test messages to insure the integrity of each system.

Selecting manual setup would allow the user to select the sub-county, county, and state (FIPS) information or directly enter the FIPS code or codes that are desired to be monitored for this alert device 300. The user would also scan for any other alert devices 300 in range of the device being set up. The user would then determine whether to link the alert device 300 with any other alert devices 300 found during the scan, thus creating the linked system 400.

Automatic setup of an alert device 300 in the linked system 400 also allows one or more alert devices 300 to be less than fully featured for the user interface 320. For example, the linked system 400 would have at least one alert device with a text display that would allow the user to fully set up that device with appropriate FIPS codes. Subsequently, the user might set up other alert devices 300 with no display, by simply pressing a setup button on the less featured device. Such an alert devices, might consist of a user interface 320 with only multicolor light emitting diodes (LEDs) to indicate the alert level sent with the SAME message. Users would only able to determine the alert details by listening to the audio broadcasts of alerts. Some users might only use one of the less-featured alert devices 300 or several of the less-featured alert devices 300 in a linked system 400 since it is conceivable that they might have their systems initialized by someone else, either a relative or retail personnel at the store where they purchased their devices.

When an alert event occurs, the signal is received by the antenna 202 of alert device 300 and demodulated into an audio signal by the radio frequency receiver 204. The audio signal is filtered by the AFSK filter 206 to remove all audio frequencies outside of the passband of the AFSK signal. The AFSK decoder 214 demodulates the AFSK signal into a logic-level serial data stream of the NWS SAME data.

The control/timing logic 314 decodes the data content of each of the three incoming SAME messages and buffers them in memory. If the control/timing logic 314 determines that the received messages are valid and without error, the control/timing logic 314 compares the geographical information in the received message with the geographic information entered by the user of the system, specifically the FIPS code and location within the user's county. If the locations match, the control/timing logic 314 reformats the weather alert information and sends the information to the user interface 320. The user interface 320 indicates some portion of the data including the type of weather condition and the severity of the alert—statement, watch, or warning. Other information that can be displayed such as the duration of the event may or may not be supported by the user interface or may be elected by the user to be turned on or off. The control/timing logic 314 starts a timer based on the duration of the event. When the timer expires, the display of the weather event is discontinued on the user interface 320.

If the WAT tone is transmitted, the WAT decoder 210 detects the 1050 Hz tone and sends a signal on the WAT output 218 to the control/timing logic 314. If the SAME messages have not been received or have been received with errors, the WAT tone may be used instead to initiate an alert condition.

After the control/timing logic 314 has determined that the received messages are valid or a WAT tone has been qualified and initiated an audio alert, alert device 404 will relay alert and status information to other linked alert devices such as alert device 408. A device 300 that receives SAME data that cannot be decoded due to poor reception will request alert and status information from other devices in its network or in range. It is anticipated that some users will only have a single unit 300 on their premises, but that those devices may link to other devices in range. An example of this would be an apartment or condominium dweller that is in close proximity to other residences. In this case, the devices 300 might exchange settings and data, but a user would have no control of other devices not on their own premises.

If the control/timing logic 314 of alert device 404 has determined that a validated WAT signal has been detected, but no SAME message has been received, alert device would initiate an audio alert from the device. Alert device 404 would then initiate a request using link transceiver 312 and antenna 310 for SAME data from another linked alert device, in this instance alert device 408. After the SAME data has been received, alert device 404 would then indicate the status level of the alert as well as the details of the alert using user interface 320.

If the alert device 404 has not received a valid SAME message or a validated WAT tone due to missing the transmission from signal errors or noise, the alert device 404 will remain in standby. However if another linked alert such as device 408 receives either the SAME message or validates the WAT tone, then alert device 408 will relay all available data to alert device 404 which will then indicate the alert condition.

During or after one of the following conditions is met, the SAME data has been determined to be valid and without error or the WAT tone has been validated, the control/timing logic 314 turns on the audio amplifier 212 using the audio control 222 so the audio from the weather alert broadcast is output to the speaker 326. If another linked device 408 cannot receive audio due to poor reception conditions or another cause, control/timing 314 can transmit the compressed audio from compressed audio stream 216 using link transceiver 312 and antenna 310.

After an alert audio cycle has been initiated by the alert devices 300 in the linked network 400, the user would move to the immediate vicinity of one of the alert devices 300. For example, the user might move to where they can interact with the user interface 320 of alert device 404. The user would then press one key of a defined set of keys of the user interface 320 that would cause the alert device 404 to send a message to other alert devices, specifically 408, in the linked network to silence their audio alert. Audio output would then be solely on unit 404. Visual alerts on other alert devices in the linked network 400 would continue and users could listen to the audio on other devices, in this case alert device 408, by pressing one key of a defined set of keys on the user interface 320 of alert device 408. Alternatively, the user could respond to an alert condition using the user interface 320 of alert device 408, thereby silencing alert device 404. A user-selectable option might also be to allow the user to silence the alarm of an alert condition, but user interaction with the user interface 320 of an alert device 300 does not silence the alert audio on other alert devices 300 in the linked network 400. As such, there might be another sequence of user interaction with the user interface 320 on an alert device 300 that silences all alert devices 300 in the alert network 400.

### Other Embodiments

It is anticipated that other embodiments of the invention might be implemented to lessen or increase functionality, decrease cost, and/or decrease complexity. An example of decreased cost would be a system using multiple LEDs, each associated with a predefined or user-specified alert, as the indicators in the user interface instead of using a general-purpose liquid crystal display to display text detailing the current alert. This would decrease system cost. Many implementations may choose to only distribute text messages, without audio, to the remote user interfaces. Audio-only remote user interfaces may be used to distribute alerts where it is not desirable or physically feasible to mount a full-featured user interface. An example would be ceiling-mounted speakers in large rooms, stairwells, etc. where sound is needed, but user interaction and user viewing of the type of alert in text form is not. In a similar fashion, multicolor LEDs, discrete LEDs of different colors, or other indicators could be used to indicate specific weather conditions without audio. Such devices would prompt the user to move to the location of more fully featured alert devices to be informed of the details of the alert condition.

It is also anticipated that another embodiment might consist of a reduced-functionality alert receiver incorporating a integrated circuit receiver such as the Silicon Laboratories Si4736 (AM/FM/Weather Band), Si4737 (AM/FM/WB), Si4738 (FM/WB), or Si4739 (FM/WB). These integrated circuits do not have the capability to decode the SAME data, but have the ability to detect the 1080 Hz tone. Thus alert receivers using these ICs do not decode the SAME data in an alert broadcast. However, the inclusion of the linking function in this embodiment would allow the alert data to be transmitted to the unit and displayed on a suitable user interface, such as an LCD for text or individual LEDs for specific alert events. The alert tone could be started after the SAME data was received and forwarded to the unit by a more capable device. This would also allow alerts to be masked on the reduced functionality devices based on the user preferences of the more capable devices. Alert receivers using the above or similar ICs can only receive one broadcast band at a time. If the user is listening to an AM or FM station the unit would otherwise miss an alert transmission, but the unit will receive a alert received message from another receiver and switch reception to the weather band so the user can hear the alert audio. A network of reduced functionality devices can also link and provide redundancy in the event that at least one unit receives an alert and another unit or units misses the alert. In all of these cases, the linking function also allows the control of remote devices when the user interacts with a unit.

It is further anticipated that another embodiment would be constructed to interface with a personal computer. This configuration would allow the user to interact with the linked system using the more feature rich and graphical visual user interface of the computer. Alternatively, another device consisting of only a computer interface with a link transceiver 312 and antenna 310 would allow similar functionality. An anticipated benefit of allowing a personal computer to communicate with the alert system is that the computer could report signal reception back to the NWS through the Internet to provide substantive data of reception patterns.

It is anticipated that linked systems with large numbers of alert devices might be used in locations such as offices, schools, hotels, etc. In such a system, one or more devices may serve as a master with the ability to change settings in other devices in the network, silence devices in unused rooms after an alert, test the network, set the time, etc. Additional functionality might be implemented to allow prerecorded messages to be played after the device has been triggered by an alert. Further, with the implementation of audio capability using the low power transceiver, the master may be used to provide real-time messages to the other alert receivers in the network. For example, after receiving a tornado alert message a user might verbalize a message such as “A tornado alert has been received, take shelter in the basement”.

While the invention has been particularly shown and described with reference to a preferred embodiment thereof, it will be understood by those skills in the art that various other changes in the form and details may be made without departing from the spirit and scope of the invention.

What is claimed is:

1. Apparatus for an announcing system for selectively annunciating, at an area encompassed by the annunciating system, an anomaly condition detected externally to the area encompassed by the annunciating system, the anomaly condition identified by an alert, the alert formed at least of a digital message, the digital message containing indicia of the anomaly condition, said apparatus comprising:
a first receiver configured to receive an indication of a warning representative of the alert identifying the anomaly condition;
a transmitter coupled to said first receiver, said transmitter configured to communicate at least indicia associated with the indication of the warning representative of the alert received by said first receiver;
a second receiver, coupled to receive at least an indication of the warning, communicated by the transmitter, representative of the alert, said second receiver for detecting reception thereat of the indications of the warning; and
an annunciator coupled to said first and second receivers, said annunciator configured to annunciate, in human perceptible form, the detection at said first and second receivers, respectively, of the indications of the warning representative of the alert anomaly.

2. The apparatus of claim 1 wherein the warning representative of the alert anomaly, the indication of which said first receiver is configured to receive, is generated external to the area encompassed by the annunciating system.

3. The apparatus of claim 2 wherein the warning representative of the alert anomaly, the indication of which said first receiver is configured to receive, comprises a radio signal generated by an weather alerting authority.

4. The apparatus of claim 3 wherein said first receiver comprises a radio receiver tunable to the publicly-accessible weather-radio band.

5. The apparatus of claim 1 wherein said transmitter and said second receiver comprise a radio transceiver corresponding to a publicly-accessible radio band.

6. The apparatus of claim 1 wherein said transmitter is configured to broadcast indicia representative of the indication of the warning representative of the alert identifying the anomaly condition to the area encompassed by the annunciating system.

7. The apparatus of claim 1 wherein said transmitter is configured to communicate a control message to the area encompassed by the annunciating system, the control message including the indicia associated with the indication of the warning.

8. The apparatus of claim 7 wherein the warning representative of the the alert that identifies the anomaly condition, the indication of which said second receiver is configured to receive, is transmitted internal to the area encompassed by the annunciating system.

9. The apparatus of claim 8 wherein said second receiver is configured to receive the control message transmitted by said transmitter internal to the area encompassed by the annunciating system.

10. The apparatus of claim 1 wherein said annunciator generates an aural annunciation of the detection of the indications of the warnings representative of the alert anomaly.

11. The apparatus of claim 1 wherein said annunciator generates a visual annunciation of the detection of the indications of the warnings representative of the alert anomaly.

12. The apparatus of claim 1 wherein said transmitter is configured to communicate a control message to the area encompassed by the annunciating system, the control message including indicia representative of configuration for the area encompassed by the annunciating system.

13. The apparatus of claim 11 wherein the control message including indicia representative of configuration, the indication of which said second receiver is configured to receive, is transmitted internal to the area encompassed by the annunciating system.

14. The apparatus of claim 12 wherein said second receiver is configured to receive the control message transmitted by said transmitter internal to the area encompassed by the annunciating system.

15. A method for annunciating an anomaly condition at an encompassing area, an improvement of a method for annunciating existence of an alert anomaly, said method comprising:
detecting reception at a first receiver of an indication of a warning representative of the alert anomaly;
detecting reception at a second receiver of the indication of a warning representative of the alert anomaly; and
broadcasting at a transmitter the indications detected by said first receiver of the warning representative of the alert anomaly; and
annunciating, in human perceptible form, the detection during said operation of detecting of the indications of the warning representative of the alert anomaly.

16. The method of claim 15 wherein the warning detected during said operation of detecting by said first receiver is generated at a location beyond the encompassing area.

17. The method of claim 15 wherein the warning detected during said operation of detecting by said first receiver comprises a radio signal generated by a weather alerting authority.

18. The method of claim 17 wherein the radio signal of which the warning detected by said first receiver during said operation of detecting is of frequency characteristics corresponding to a publicly-accessible weather radio band.

19. The method of claim 15 wherein the radio signal of which the warning detected by said second receiver during said operation of detecting is of frequency characteristics corresponding to a publicly-accessible band.

20. The method of claim 15 wherein the radio signal of the warning broadcast by said transmitter during said operation of transmitting is of frequency characteristics corresponding to a publicly-accessible band.

21. The method of claim 15 wherein said operation of annunciating comprises aurally annunciating the detection of the indications of the warning.

22. The method of claim 15 wherein said operation of annunciating comprises visually annunciating the detection of the indications of the warning.

23. The method of claim 20 wherein said operation of transmitting comprises a control message including the indicia associated with the indication of the warning.
